(19) United States
(12) Patent Application Publication
(10) Pub. No.: US 2014/0203681 A1
(43) Pub. Date: Jul. 24, 2014

(54) Small-size or Micro Electric Machine and Its Stator Iron Core

(71) Applicants: Xinyi XIANG, Shenzhen (CN); Jiakuan WU, Shenzhen (CN)

(72) Inventors: Xinyi XIANG, Shenzhen (CN); Jiakuan WU, Shenzhen (CN)

(21) Appl. No.: 14/062,505

(22) Filed: Oct. 24, 2013

(30) Foreign Application Priority Data
Jan. 21, 2013 (CN) 201320028097.8

(51) Int. Cl. H02K 1/16

(52) U.S. Cl. CPC H02K 1/165
USPC 310/216.111; 310/216.001

(57) ABSTRACT

A small-size or micro electric machine and its stator iron core. Such machine comprises rotor assembly and stator assembly installed between front & rear end covers; the stator assembly also includes the stator iron core evenly set with multiple stator slots; the bottom width of the stator slot is as 7-10 times large as the opening width of the stator slot; the shoulder width of the stator slot is as 4-7 times large as the opening width of the stator slot; the slot bottom width of the stator slot is as 1.3-2.0 times large as the slot shoulder width of the stator slot. The said small-size or micro electric machine has advantages of lower input power, higher efficiency and higher output moment of force, that is a high-efficient and energy-saving electric machine.

### TECHNICAL FIELD

This invention relates to small-size and micro electric machines, especially to the stator iron core of the small-size or micro electric machine.

### BACKGROUND ART

Small-size and micro electric machines such as a kind of small-size and micro single-phase capacitor motor are widely used as electric machines among modern domestic appliances. As can be shown in FIGS. 14 & 15, the stator iron core 11′ for the small-size and micro single-phase capacitor motors are formed by laminating multiple stator punching. Such stator iron core 11′ comprises the central through-hole 112 and multiple evenly distributed stator slots 111′. Multiple stator windings are inlaid in multiple stator slots 111′. As is affected by the shape and size of the stator slot 111′ for the stator iron core 11′, shortcomings such as high input power, low efficiency and low output moment of force for the electric machine are incurred; meanwhile, as is affected by the shape and size of the stator slot 111′ for the stator iron core 11′, generally multiple stator windings will be inlaid in multiple stator slots 111′ with the aid of a machine or manually after the said stator windings have been enwound at the coil-winding machine, thus causing low production efficiency and high ratio of defective goods.

### CONTENTS OF THE INVENTION

The technical problem the invention aims to settle lies in avoiding the aforementioned shortcomings for prior art and providing a kind of small-size or micro electric machine and its stator iron core where the enameled wire has been enwound inside multiple stator slots of the stator iron core directly by means of winding devices just once, thus granting it strengths of high production efficiency, good quality, high ratio to be qualified and low cost. Compared to the small-size or micro electric machine with equivalent specifications, it has strengths of low input power, high efficiency and high output moment of force, which is a high-efficient and energy-saving electric machine.

The technical solution adopted by the invention so as to resolve the said technical problem is that:

A small-size or micro electric machine is provided, comprising the rotor assembly and front & rear end covers as well as the stator assembly installed between such front & rear end covers; the said stator assembly also includes the stator iron core evenly set with multiple stator slots and multiple stator windings inlaid in such stator iron core; the said rotor assembly is rotatably set between the said front & rear end covers, and the radial air gap is formed between the outer surface of the said rotor assembly and the central through-hole of the said stator iron core; the slot bottom width for the said stator slot is as 7-10 times large as the slot opening width for the stator slot, especially the slot bottom width for the said stator slot is as 8.5-9.5 times large as the slot opening width for the stator slot, for example the slot bottom width for the said stator slot is as 9.3 times large as the slot opening width for the stator slot; the slot shoulder width for the said stator slot is as 4-7 times large as the slot opening width for the stator slot, especially the slot shoulder width for the said stator slot is as 5.5-6.5 times large as the slot opening width for the stator slot 111, for example the slot shoulder width for the said stator slot is as 6.3 times large as the slot opening with for the stator slot; the slot bottom width for the said stator slot is as 1.3-2.0 times large as the slot shoulder width for the stator slot, especially the slot bottom width for the said stator slot is as 1.4-1.7 times large as the slot shoulder width for the stator slot, for example the slot bottom width for the said stator slot is as 1.5 times large as the slot shoulder width for the stator slot.

The height for the said stator slot is as 0.22-0.28 times large as the inner diameter for the said stator iron core, especially the height for the said stator slot is as 0.23-0.27 times large as the inner diameter for the said stator iron core, for example the height for the said stator slot is as 0.25 times large as the inner diameter for the said stator iron core.

The inner diameter for the said stator iron core is 46.0±1.0 mm; such stator iron core is evenly set with 8 stator slots and the tooth width between two adjacent stator slots is 7.0±0.3 mm; the slot opening width for the said stator slot is 1.9-2.2 mm; the slot bottom width for the said stator slot is 18.0-19.0 mm; the slot shoulder width for the said stator slot is 12.0-13.0 mm; and the height for the said stator slot is 11.2-12.2 mm.

In particular, the inner diameter of the said stator iron core is 46.0 mm; such stator iron core is evenly set with 8 stator slots and the tooth width between two adjacent stator slots is 7.0 mm; the slot opening width for the said stator slot is 2.0 mm; the slot bottom width for the said stator slot is 18.56 mm; the slot shoulder width for the said stator slot is 12.48 mm; and the height for the said stator slot is 11.7 mm.

The said stator assembly also comprises the first insulating frame for stators and second insulating frame for stators; the said first insulating frame for stators includes the first central through-hole whose inner diameter slightly exceeds or equals that for the said stator iron core as well as the first insulating convex slot that adapts to and has the same quantity with stator slots of the said stator iron core, and every first insulating convex slots are set with the first slot opening linking up with the said first central through-hole; the said second insulating frame for stators also includes the second central through-hole whose inner diameter slightly exceeds or equals that for the said stator iron core as well as the second insulating convex slot that adapts to and has the same quantity with stator slots of the said stator iron core, and every second insulating convex slots are set with the second slot opening linking up with the said second central through-hole; multiple first insulating convex slots of the first insulating frame for stators and multiple second insulating convex slots of the second insulating frame for stators are respectively inlaid and mutually spliced from both ends of multiple stator slots corresponding to the said stator iron core, and the respective wall space of the said first insulating frame for stators and the second insulating frame for stators cling to two end faces of the said stator iron core; multiple stator windings are enwound inside multiple first insulating convex slots and multiple second insulating convex slots in multiple stator slots of the said stator iron core.

The first insulating frame for the said stator is surrounded by a circle of first bulges and multiple positioning bars in the opposite direction to the first insulating convex slot, and gaps are reserved between such positioning bars and the first bulges; the second insulating frame for the said stator is also surrounded by a circle of second bulges in the opposite direction to the second insulating convex slots. Therefore, the external part of multiple stator windings can be restricted by multiple positioning bars of the first insulating frame for the said stator and a circle of second bulges of the second insulating frame for stators; the inter-coil connection for multiple coils of the stator winding can be clutched at the gaps between the first bulge of the first insulating frame for stators and the positioning bar.

The edge of the first central through-hole of the first insulating frame for the said stator is outwards set with multiple bulges in the same direction with the said first bulge; the edge of the first central through-hole of the second insulating frame for the said stator is outwards set with multiple bulges in the same direction with the said second bulge. Therefore, the internal circle of multiple stator windings can be restricted by the bulges of the first insulating frame for the said stator and the bulges of the second insulating frame for stators.

A stator iron core applied to the small-size or micro electric machine is provided. Such stator iron core comprises the central through-hole and multiple evenly distributed stator slots. The slot bottom width for the said stator slot is as 7-10 times large as the slot opening width for the stator slot; the slot shoulder width for the said stator slot is as 4-7 times large as the slot opening width for the stator slot; and the slot bottom width for the said stator slot is as 1.3-2.0 times large as the slot shoulder width for the stator slot.

Compared to the prior art, the beneficial effects for the small-size or micro electric machine of this invention consists that:

1. As special design with respect to multiple stator slots for the stator iron core is conducted, the enameled wire has been enwound directly inside the stator slots for the stator iron core by means of winding devices just once, thus enabling the small-size or micro electric machine for this invention to have strengths of high production efficiency, good quality, high ratio to be qualified and low cost. Compared to the small-size or micro electric machine with equivalent specifications, this kind of electric machine has advantages of low input power, high efficiency and high output moment of force, which is a high-efficient and energy-saving electric machine.

2. As the insulating slot paper inside multiple stator slots for the stator iron core with prior art is easy to be damaged and multiple stator windings are not fastened well, it is specially designed in this invention that the first insulating frame for stator and second insulating frame for stator inlaid inside multiple stator slots for the stator iron core will be utilized to replace the insulating slot paper inside multiple stator slots for the stator iron core with the prior art. Therefore, in the small-size or micro electric machine for this invention when the enameled wire has been enwound inside the stator slots for the stator iron core by means of winding devices just once, the first insulating frame for stator and the second insulating frame for stator will not be damaged; meanwhile, a circle of first bulges surrounding the first insulating frame for stator and multiple positioning bars as well as a circle of second bulges surrounding the second insulating frame for stator will play a good role in restricting and fastening multiple stator windings.

### DESCRIPTION OF FIGURES

FIG. 1 is the orthogonal projection sectional sketch map on the preferable embodiment I of the small-size or micro electric machine for this invention.

FIG. 2 is the axonometric projection sketch map on the stator iron core for the preferable embodiment I as shown in FIG. 1.

FIG. 3 is a front view of the orthogonal projection sketch map for the stator iron core as shown in FIG. 2.

FIG. 4 is the orthogonal projection sectional sketch map on the preferable embodiment II of the small-size or micro electric machine for this invention.

FIG. 5 is the axonometric projection sketch map on the stator iron core for the preferable embodiment II as shown in FIG. 4.

FIG. 6 is a front view of the orthogonal projection sketch map for the stator iron core as shown in FIG. 5.

FIG. 7 is the axonometric projection sketch map on the first insulating frame for stators of the said small-size or micro electric machine.

FIG. 8 is the axonometric projection sketch map on the first insulating frame for the said stator in the other direction.

FIG. 9 is the axonometric projection sketch map on the second insulating frame for stators of the said small-size or micro electric machine.

FIG. 10 is the axonometric projection sketch map on the second insulating frame for the said stator in the other direction.

FIG. 11 is the simple circuit schematic diagram on the stator winding of a preferable embodiment when the said small-size or micro electric machine is the single-phase capacitor electric motor. Such stator winding 12 comprises the principal winding 121 and auxiliary winding 122. Such auxiliary winding 122 also includes the first auxiliary winding 1221, second auxiliary winding 1222 and third auxiliary winding 1223.

FIG. 12 is the outspread schematic diagram for the principal winding 121 as shown in FIG. 11.

FIG. 13 is the outspread schematic diagram for the auxiliary winding 122 as shown in FIG. 11.

FIG. 14 is the axonometric projection sketch map on the stator iron core for the small-size or micro electric machine with prior art.

FIG. 15 is the axonometric projection sketch map on the stator iron core for the small-size or micro-electric machine of another specifications with prior art.

### MODE OF CARRYING OUT THE INVENTION

Now, further detailed instructions will be made on the invention combining various attached drawings.

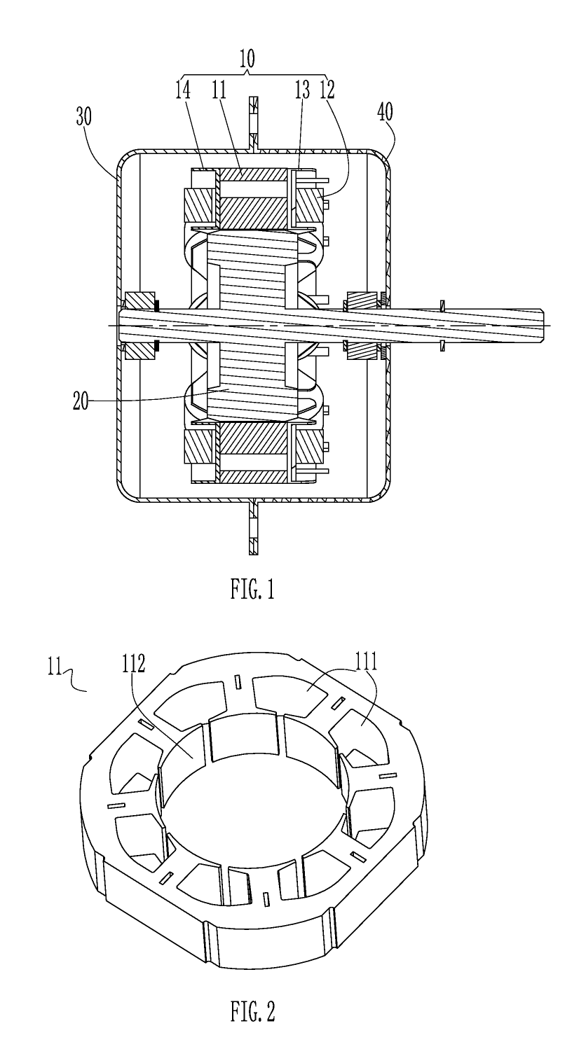

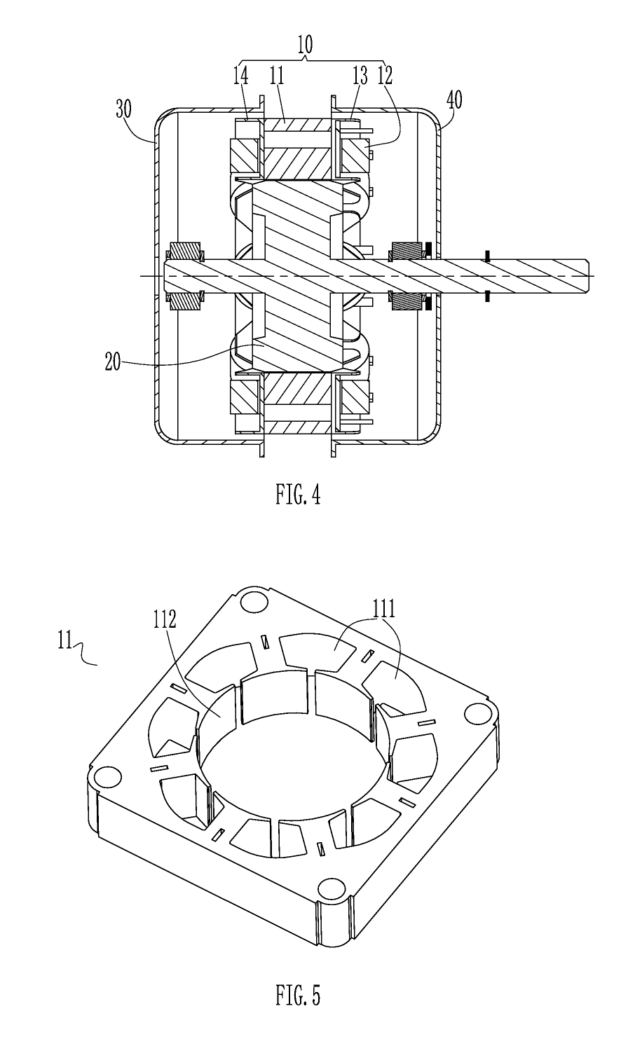

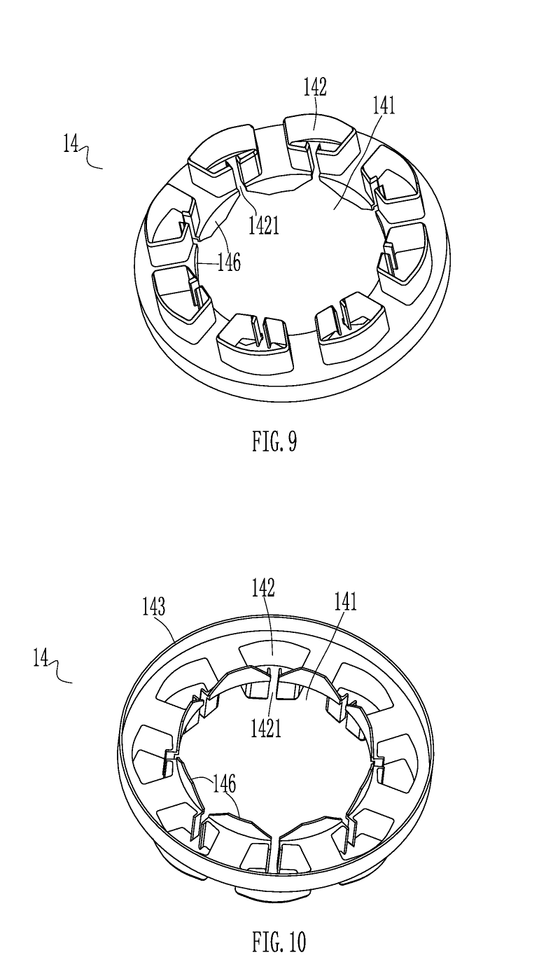

As can be shown in FIGS. 1 to 13, a small-size or micro electric machine, comprising the rotor assembly 20 and front & rear end covers 30, 40 as well as the stator assembly 10 installed between such front & rear end covers 30, 40; the said stator assembly 10 also includes the stator iron core 11 evenly set with multiple stator slots 111, and multiple stator windings 12 inlaid into stator slots 111 of such stator iron core 11; the said rotor assembly 20 rotatably set between the said front & rear end covers 30, 40, and the radial air gap is formed between the outer surface of the said rotor assembly 20 and the central through-hole 112 of the said stator iron core 11; the slot bottom width bₛ₂ of the said stator slot 111 is as 7-10 times large as the slot opening width b₀ of the stator slot 111, especially the slot bottom width bₛ₂ of the said stator slot 111 is as 8.5-9.5 times large as the slot opening width b₀ of the said stator slot 111, for example the slot bottom width bₛ₂ of the said stator slot 111 is as 9.3 times large as the slot opening width b₀ of the stator slot 111; the slot shoulder width bₛ₁ of the said stator slot 111 is as 4-7 times large as the slot opening width b₀ of the stator slot 111, especially the slot shoulder width bₛ₁ of the said stator slot 111 is as 5.5-6.5 times large as the slot opening width b₀ of the stator slot 111, for example the slot shoulder width bₛ₁ of the said stator slot 111 is as 6.3 times large as the slot opening width b₀ of the stator slot 111; and the slot bottom width bₛ₂ of the said stator slot 111 is as 1.3-2.0 times large as the slot shoulder width bₛ₁ of the stator slot 111, especially the slot bottom width bₛ₂ of the said stator slot 111 is as 1.4-1.7 times large as the slot shoulder width bₛ₁ of the stator slot 111, for example the slot bottom width bₛ₂ of the said stator slot 111 is as 1.5 times large as the slot shoulder width bₛ₁ of the stator slot 111.

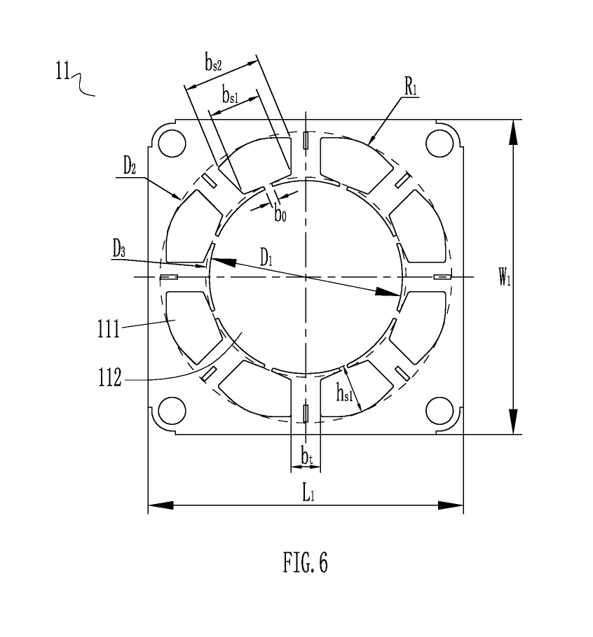

Referring to FIG. 3 and FIG. 6, the height hₛ₁ of the said stator slot 111 is as 0.22-0.28 times large as the inner diameter D₁ of the said stator iron core 11, especially the height h₁ of the said stator slot 111 is as 0.23-0.27 times large as the inner diameter D₁ of the said stator iron core 11, for example the height h₁ of the said stator slot 111 is as 0.25 times large as the inner diameter D₁ of the said stator iron core 11.

The label L₁ as shown in FIG. 3 and FIG. 6 represents the length of the stator iron core 11 and the label W₁ refers to the width of the stator iron core 11; the slot bottoms of the stator slots 111 of the stator core iron are circular arcs with the radius of R₁; the slot bottoms of the stator slots 111 fall on a circle with the diameter of D₂; the inner surface of the slot opening of the stator slots 111 fall on a circle with the diameter of D₃; and the label D₄ represents the diameter for any one of four circular arcs of an outline of the preferable embodiment I for the stator iron core 11.

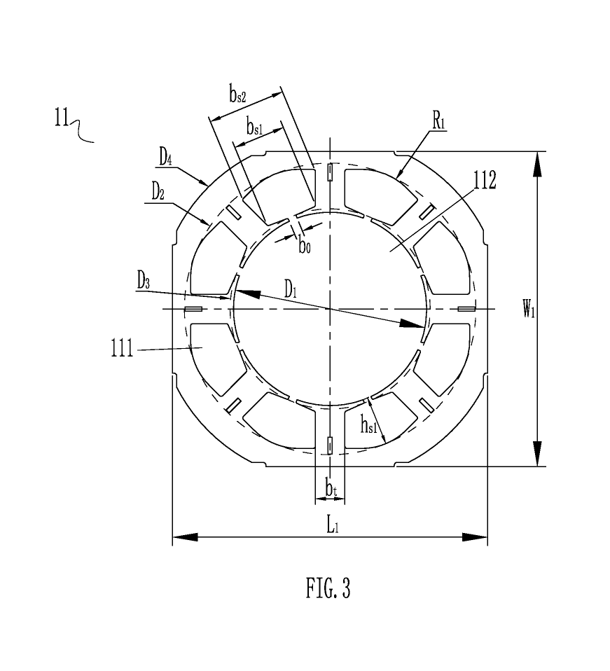

Referring to FIGS. 2, 3, 5 & 6, the inner diameter D₁ for the said stator iron core 11 is 46.0±1.0 mm; such stator iron core 11 is evenly set with 8 stator slots 111 and the tooth width bₜ between two adjacent stator slots 111 is 7.0±0.3 mm; the slot opening width b₀ for the said stator slot 111 is 1.9-2.2 mm; the slot bottom width bₛ₂ for the said stator slot 111 is 18.0-19.0 mm; the slot shoulder width bₛ₁ for the said stator slot 111 is 12.0-13.0 mm; the height h₁ for the said stator slot is 11.2-12.2 mm. Correspondingly, the length L₁ for the stator iron core 11 in FIGS. 3 & 6 can be designed as 75.0±1.0 mm, the width W₁ for the stator iron core 11 is also designed as 75.0±1.0 mm, the slot bottom circular arc radius R₁ for the stator slots 111 of the stator iron core 11 is contrived as 15.0±0.3 mm, D₂ is designed as φ69.4±0.5 mm, D₃ is designed as 47.6±0.5 mm and D₄ is contrived as φ82.0±1.0 mm.

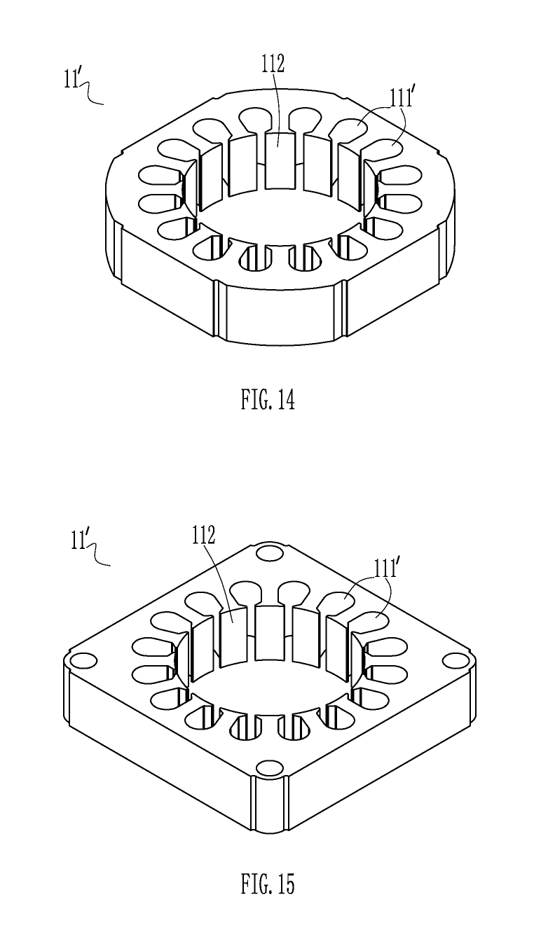

Referring to FIGS. 2, 3, 5 & 6, the inner diameter D₁ of the said stator iron core 11 is 46.0 mm; such stator iron core 11 is evenly set with 8 stator slots 111 and the tooth width bₜ between two adjacent stator slots 111 is 7.0 mm; the slot opening width b₀ for the said stator slot 111 is 2.0 mm; the slot bottom width bₛ₂ for the said stator slot 111 is 18.56 mm; the slot shoulder width bₛ₁ for the said stator slot 111 is 12.48 mm; the height h₁ for the said stator slot 111 is 11.7 mm. Correspondingly, both the length L₁ and width W₁ for the stator iron core 11 in FIGS. 3 & 6 can be designed as 75 mm, the slot bottom circular arc radius R₁ for the stator slots 111 of the stator iron core 11 is designed as 15.0 mm, D₂ is contrived as φ69.4 mm, D₃ is designed as 47.6 mm and D₄ is designed as 82.0 mm. As for the capacitor electric motor adopting the above-mentioned dimensions, if the laminated thickness of the stator iron core 11 is designed as 16 mm, the outer diameter for the rotor assembly 20 is 45.45 mm; meanwhile the laminated thickness of rotor iron core is designed as 15.5 mm, the principal winding 121 (totaling 680 turns) for the stator winding 12 is made from the enameled wire with the diameter of 0.17 mm; the first auxiliary winding 1221 of the auxiliary winding 122, the second auxiliary winding 1222 and the third auxiliary winding 1223 are made respectively in form of φ0.17 mm×305 turns, φ0.15 mm×130 turns and φ0.15 mm×100 turns. The input power for such single phase capacitor electric motor only requires about 30 W, while the output moment of force can reach 70 N-m and has the efficiency of 34%. Referring to FIGS. 14 & 15, under the condition of equivalent specifications, namely, identical length L₁ for the stator iron core 11, width W₁ and thickness as well as identical rotor assembly 20, the input power for the single phase capacitor electric motor with prior art requires about 52 W, while the output moment of force only reaches 40 N-m and only has the efficiency of 11%. As a result, under the condition of equivalent specifications, the small-size or micro electric machine of the present invention has strengths of low input power, high efficiency and high output moment of force, which is authentically an energy-saving electric machine.

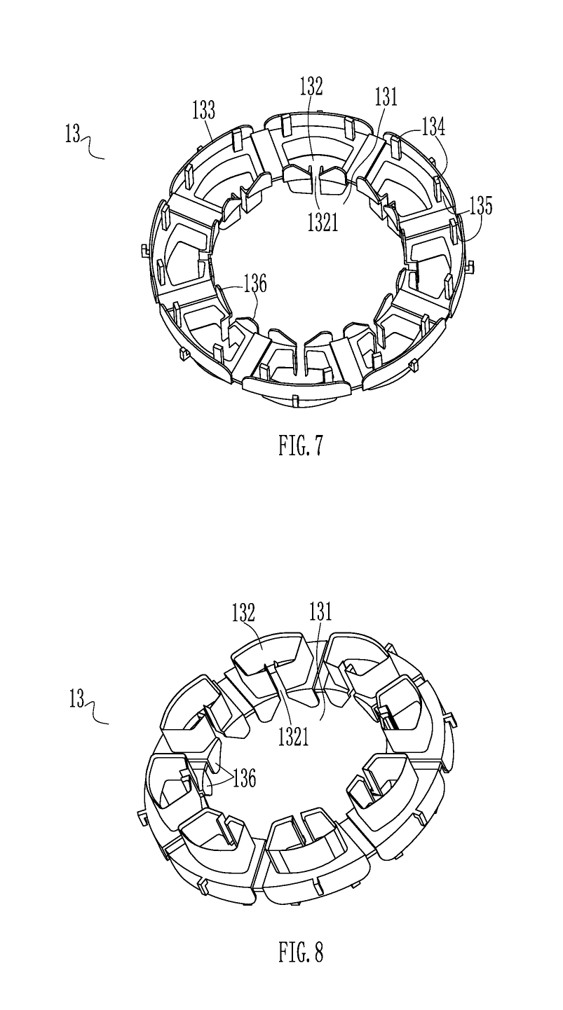

Referring to FIG. 1, 2, 4, 5 as well as FIG. 7-9, the said stator assembly 10 also comprises the first insulating frame 13 for stators and second insulating frame 14 for stators; the said first insulating frame 13 for stators includes the first central through-hole 131 whose inner diameter slightly exceeds or equals that for the said stator iron core 11 as well as the first insulating convex slot 132 that adapts to and has the same quantity with the stator slots 111 of the said stator iron core 11, and every first insulating convex slots 132 are set with the first slot opening 1321 linking up with the said first central through-hole 131; the said second insulating frame 14 for stators also includes the second central through-hole 141 whose inner diameter slightly exceeds or equals that for the said stator iron core 11 as well as the first insulating convex slot 142 that adapts to and has the same quantity with the stator slots 111 of the said stator iron core 11, and every second insulating convex slots 142 are set with the second slot opening 1421 linking up with the said second central through-hole 141; every first insulating convex slots 132 of the first insulating frame 13 for stators and every second insulating convex slots 142 of the second insulating frame 14 for stators are respectively inlaid and mutually spliced from both ends of stator slots 111 corresponding to the said stator iron core 11, and the respective wall space of the said first insulating frame 13 for stators and the second insulating frame 14 for stator cling to two end faces of the said stator iron core 11; multiple stator windings 12 are enwound inside first insulating convex slots 132 and second insulating convex slots 142 in stator slots 111 of the said stator iron core 11.

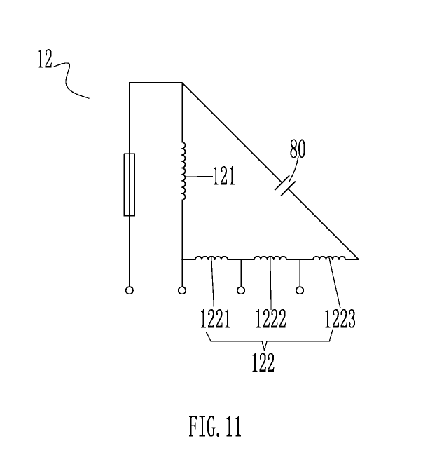

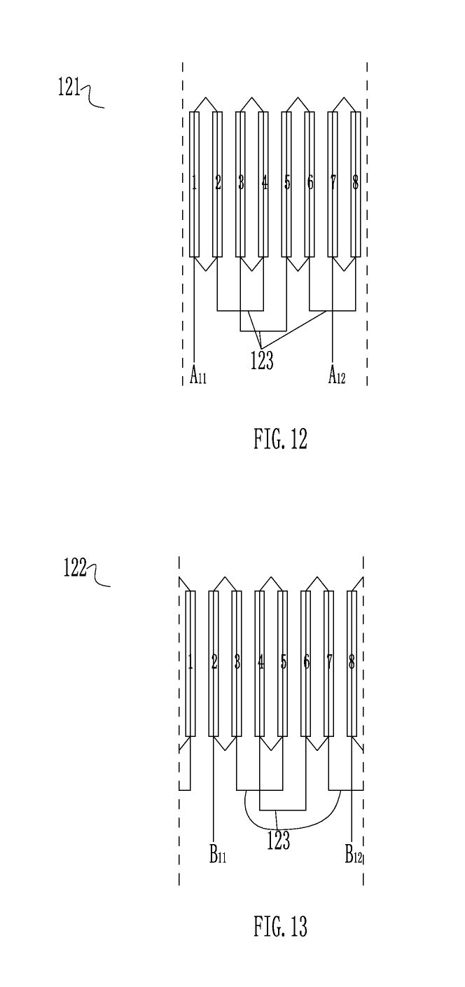

The label 80 in FIG. 11 represents the capacitor. label 1-8 in FIGS. 12 & 13 means the sequential numbers for the stator slots 111 of the stator iron core 11. For instance, the stator slot No. 1 with label 111, the stator slot No. 2 with label 111, and the rest can be done in the same manner; labels A11 and A12 respectively represent the head and tail of the principal winding 121, and labels B11 and B12 respectively refer to the head and tail of the auxiliary winding 122. Label 123 refers to the inter-coil connection for the coils of the stator winding 12.

Referring to FIGS. 1, 2, 4 & 5, as well as FIG. 7-9, FIGS. 12 & 13, the first insulating frame 13 for the said stator is surrounded by a circle of first bulges 133 in the opposite direction to the first insulating convex slot 132 and multiple positioning bars 134, and gaps are reserved between every such positioning bars 134 and the first bulge 133; the second insulating frame 14 for the said stator is also surrounded by a circle of second bulge 143 in the opposite direction to the second insulating convex slot 142. Therefore, the external part of the stator windings 12 can be restricted by multiple positioning bars 134 of the first insulating frame 13 for the said stator and a circle of second bulge 143 of the second insulating frame 14 for stators; the inter-coil connection 123 for multiple coils of the stator winding 12 can be clutched at the gaps 135 between the first bulge 133 of the first insulating frame 13 for stators and the positioning bar 134.

Referring to FIGS. 1, 2, 4 & 5 as well as FIG. 7-9, FIGS. 12 & 13, the edge of the first central through-hole 131 of the first insulating frame 13 for the said stator is outwards set with multiple bulges 136 in the same direction with the said first bulge 133; the edge of the first central through-hole 141 of the second insulating frame 14 for the said stator is outwards set with multiple bulges 146 in the same direction with the said second bulge 143. Therefore, the internal circle of the stator windings 12 can be restricted by the bulges 136 of the first insulating frame 13 for the said stator and the bulges 146 of the second insulating frame 14 for stators.

The above-mentioned embodiments are specifically described in detail by means of only expressing the preferable executive methods of the present invention, which shall not thereby be understood as limitations to the scope of the said invention patent; it shall be pointed out that several variations and improvements can be made by ordinary technicians in the art without departing from the conception of the present invention, which are included within the protection scope therein; therefore, any and all equivalent alterations and modifications made within the scope of claims of the present invention are covered by the claims of the present invention.

What is claimed is:

1. A small-size or micro electric machine, comprising:
the rotor assembly and front & rear end covers as well as the stator assembly installed between such front & rear end covers;
the said stator assembly also includes the stator iron core evenly set with multiple stator slots, and multiple stator windings inlaid into the stator slots of such stator iron core;
the said rotor assembly is rotatably set between the said front & rear end covers, and the radial air gap is formed between the outer surface of the said rotor assembly and the central through-hole of the said stator iron core; and
the slot bottom width of the said stator slot is as 7-10 times large as the slot opening width of the stator slot, the slot shoulder width of the said stator slot is as 4-7 times large as the slot opening width of the stator slot, and the slot bottom width of the said stator slot is as 1.3-2.0 times large as the slot shoulder width of the stator slot.

2. The small-size or micro electric machine as set forth in claim 1, wherein the height of the said stator slot is as 0.22-0.28 times large as the inner diameter of the said stator iron core.

3. The small-size or micro electric machine as set forth in claim 1, further comprising:
the inner diameter of the said stator iron core is 46.0±1.0 mm; wherein said stator iron core is evenly set with 8 stator slots and the tooth width between two adjacent stator slots is 7.0±0.3 mm, and the slot opening width of said stator slot is 1.9-2.2 mm, the slot bottom width of the said stator slot is 18.0-19.0 mm, the slot shoulder width of the said stator slot is 12.0-13.0 mm and the height of the said stator slot is 11.2-12.2 mm.

4. The small-size or micro electric machine as set forth in claim 1, further comprising:
the inner diameter of the said stator iron core is 46.0 mm; wherein said stator iron core is evenly set with 8 stator slots and the tooth width between two adjacent stator slots is 7.0 mm, the slot opening width of the said stator slot is 2.0 mm, the slot bottom width of the said stator slot is 18.56 mm, the slot shoulder width of the said stator slot is 12.48 mm and the height of the said stator slot is 11.7 mm.

5. The small-size or micro electric machine as set forth in any item of claim 1-4, wherein the said stator assembly further comprising:
the first insulating frame for stator and second insulating frame for stator; the first insulating frame for stator including the first central through-hole whose inner diameter slightly exceeds or equals that of the said stator iron core as well as the first insulating convex slot that adapts to and has the same quantity with the stator slots of the said stator iron core, and every first insulating convex slot is set with the first slot opening linking up with the said first central through-hole; the said second insulating frame for stator also having the second central through-hole whose inner diameter slightly exceeds or equals that of the said stator iron core as well as the second insulating convex slot that adapts to and has the same quantity with the stator slots of the said stator iron core, and every second insulating convex slot is set with the second slot opening linking up with the said second central through-hole; every first insulating convex slot of the first insulating frame for stator and every second insulating convex slot of the second insulating frame for stator are respectively inlaid and mutually spliced from both ends of stator slots corresponding to the said stator iron core, and the respective end wall of the said first insulating frame for stator and the second insulating frame for stator cling to two end faces of the said stator iron core; and
a polarity of multiple stator windings are enwound inside first insulating convex slots and second insulating convex slots in stator slots of the said stator iron core.

6. The small-size or micro electric machine as set forth in claim 5, wherein said first insulating frame for stator is surrounded by a circle of first bulges and multiple positioning bars in the opposite direction to the first insulating convex slots, and gaps are reserved between such positioning bars and the first bulge; and
said second insulating frame for stator is also surrounded by a circle of second bulge in the opposite direction to the second insulating convex slots.

7. A stator iron core applied to the small-size or micro electric machine, comprising:
the central through-hole and multiple evenly distributed stator slots; wherein the slot bottom width of the said stator slot is as 7-10 times large as the slot opening width of the stator slot; the slot shoulder width of the said stator slot is as 4-7 times large as the slot opening width of the stator slot;
wherein the slot bottom width of the said stator slot is as 1.3-2.0 times large as the slot shoulder width of the stator slot.

8. The stator iron core applied to the small-size or micro electric machine as set forth in claim 7, wherein the height of the said stator slot is as 0.22-0.28 times large as the inner diameter of the said stator iron core.

9. The stator iron core applied to the small-size or micro electric machine as set forth in claim 7 or 8, further comprising:
the inner diameter of the said stator iron core is 46.0±1.0 mm; wherein said stator iron core is evenly set with 8 stator slots and the tooth width between two adjacent stator slots is 7.0±0.3 mm; the slot opening width of the said stator slot is 1.9-2.2 mm; the slot bottom width of the said stator slot is 18.0-19.0 mm; the slot shoulder width of the said stator slot is 12.0-13.0 mm; and the height of the said stator slot is 11.2-12.2 mm.

10. The stator iron core applied to the small-size or micro electric machine as set forth in claim 7 or 8, wherein the inner diameter of the said stator iron core is 46.0 mm; wherein said stator iron core is evenly set with 8 stator slots and the tooth width between two adjacent stator slots is 7.0 mm; the slot opening width of the said stator slot is 2.0 mm; the slot bottom width of the said stator slot is 18.56 mm; the slot shoulder width of the said stator slot is 12.48 mm; and the height of the said stator slot is 11.7 mm.
